(19) United States
(12) Patent Application Publication
(10) Pub. No.: US 2025/0052587 A1
(43) Pub. Date: Feb. 13, 2025

(54) Location Sharing Interactivity

(71) Applicant: Google LLC, Mountain View, CA (US)

(72) Inventor: Matthew Sharifi, Kilchberg (CH)

(21) Appl. No.: 18/287,332

(22) PCT Filed: Sep. 28, 2022
(86) PCT No.: PCT/US2022/045037

§ 371 Date: Oct. 18, 2023

(51) Int. Cl. G01C 21/34; H04L 67/52

(52) U.S. Cl. CPC G01C 21/3484; H04L 67/52

(57) ABSTRACT

The technology is generally directed to providing a next suggested action based on a first user's request for location information of a second user and the location information of the second user. Location information may be shared between the first and second user after each user authorizes location sharing with specific users. The second user's location information may be provided to the first user in response to a request for the first user. Based on the request from the first user and the location information of the second user, a next suggested action may be automatically determined and provided to the first or second user. The suggested next action may be for the first user to send a message to the second user, the second user to send a message to the first user or another user, updating a navigation route, providing an update to a scheduled event, etc.

### BACKGROUND

A user can share their location with other users by authorizing mapping applications to share their location with selected users. Location sharing can display the locations of users that have provided authorization. Location sharing can be useful when two or more users will be meeting up in person and want to coordinate and orient themselves relative to one another. Coordinating the location of users may be manually intensive for a user and assumes that the user is able to be actively engaging with a mapping application. However, when a user is driving or cycling, it may not be possible for the user to engage with the mapping application. Moreover, it may require a large amount of computational resources to continually update the location of the users.

### BRIEF SUMMARY

The technology is generally directed to providing a next suggested action based on a first user's request for location information of a second user and the location information of the second user. Location information may be shared between the first and second user after each user authorizes location sharing with specific users. The second user's location information may be provided to the first user in response to a request for the first user. Based on the request from the first user and the location information of the second user, a next suggested action may be automatically determined. The suggested next action may be provided to the first or second user. For example, the suggested next action may be for the first user to send a message to the second user, the second user to send a message to the first user or another user, updating a navigation route, providing an update to a scheduled event, etc. In some examples, the suggested next action may be based on a response from the first user to the second user based on the location information of the second user received by the first user.

One aspect of the technology is directed to a method, comprising: receiving, by one or more processors from a first or second user, a request for location information for the second user, receiving, by the one or more processors based on an occurrence of a trigger condition, location information from the second user, automatically determining, by the one or more processors based on at least the request for location information from the first user and the location information of the second user, at least one suggested next action, and providing for output, by the one or more processors, the at least one suggested next action.

Identifying the trigger condition may further comprise identifying, by the one or more processors, at least one parameter from the request for location information. Identifying the at least one parameter may be based on historical requests for location information or context of the request for location information.

The method may further comprise receiving, by the one or more processors, a response from the first user destined for the second user, wherein the response relates to the location information of the second user. Determining the at least one suggested next action may be further based on the response.

The method may further comprise receiving, by the one or more processors from the second user, a request for directions to a destination location, and providing, by the one or more processors, a navigation route to the destination location. The at least one suggested next action may include updating the navigation route. The method may further comprise receiving, by the one or more processors, a response from the first user destined for the second user, wherein the response includes navigation information, and wherein updating the navigation route comprises automatically updating the navigation route based on the navigation information. The method may further comprise receiving, from the first user, a communication including information associated with the location information, and interleaving, by the one or more processors, the information associated with the location information with the navigation route. The information associated with the location information may include a warning or a navigation suggestion.

Automatically determining the at least one suggested next action may comprise: identifying, with the one or more processors, an event scheduled for the second user, the event having an event time and an event location, comparing the location information with the event location, determining, based on the comparing, an estimated arrival time of the second user at the event location, and determining, based on the event time and the estimated arrival time, whether to send a second notification related to the event. The at least one suggested next action may comprise sending the second notification to a third party.

The trigger condition may limit a frequency of receiving the location information from a second user device of the second user. The method may further comprise transmitting, by the one or more processors to the first user, a first notification based on the received location information, wherein the first notification is a response to the request for location information.

Another aspect of the technology is directed to a system, comprising one or more processors. The one or more processors may be configured to receive, from a first user, a request for location information for a second user, receive, based on an occurrence of a trigger condition, location information from the second user, automatically determine, based on at least the request for location information from the first user and the location information of the second user, at least one suggested next action, and provide for output the at least one suggested next action.

Yet another aspect of the technology is directed to a computer-readable medium storing instructions, which may be non-transitory, and which when executed by one or more processors, cause the one or more processors to: receive, from a first user, a request for location information for a second user, receive, based on an occurrence of a trigger condition, location information from the second user, automatically determine, based on at least the request for location information from the first user and the location information of the second user, at least one suggested next action, and provide for output the at least one suggested next action.

### BRIEF DESCRIPTION OF THE DRAWINGS

FIG. 1A is a pictorial diagram of an example request for location information in accordance with aspects of the disclosure.

FIG. 1B is a pictorial diagram of an example notification in accordance with aspects of the disclosure.

FIG. 2 is an example screenshot illustrating an example authorization for location sharing in accordance with aspects of the disclosure.

FIG. 3A is a pictorial diagram of an example next suggested action to a first user in accordance with aspects of the disclosure.

FIG. 3B is a pictorial diagram of an example next suggested action to a second user in accordance with aspects of the disclosure.

FIG. 4A is a pictorial diagram of an example communication in response to the next suggested action in accordance with aspects of the disclosure.

FIG. 4B is an example screenshot illustrating an example notification based on the next suggested action of FIG. 4A in accordance with aspects of the disclosure.

FIG. 5A is an example screenshot illustrating an example next suggested action to a second user in accordance with aspects of the disclosure.

FIG. 5B is an example screenshot illustrating an updated navigation route based on the next suggested action of FIG. 5A in accordance with aspects of the disclosure.

FIG. 6A is an example screenshot illustrating an example next suggested action to a second user in accordance with aspects of the disclosure.

FIG. 6B is a pictorial diagram of an example notification to a third party based on the next suggested action of FIG. 6A in accordance with aspects of the disclosure.

FIGS. 7A-7B are example screenshots illustrating an example next suggested action related to an event in accordance with aspects of the disclosure.

FIG. 7C is a pictorial diagram of an example notification based on the next suggested action of FIG. 7B in accordance with aspects of the disclosure.

FIGS. 8A-8B are example screenshots illustrating example interleaved audio in accordance with aspects of the disclosure.

FIG. 9 is a functional block diagram of an example system in accordance with aspects of the disclosure.

FIG. 10 is a flow diagram for an example method of determining a next suggested action in accordance with aspects of the disclosure.

### DETAILED DESCRIPTION

The technology is generally directed to providing a system for reporting location information to approved users and facilitating interactions between the users based on the reported location information. Location information may be shared among two or more users after each of the two or more users authorizes the location sharing. For example, the location information of a second user may be provided in response to a request from a first user. Based on the request from the first user and the location information of the second user, a suggested next action may be automatically determined. The suggested next action may be provided to the first user, the second user, or both. Examples of suggested next actions include sending a message to the other user, updating a navigation route, providing an update for a scheduled event, etc. According to some examples, the suggested next action may be based on a communication from the first user to the second user that is responsive to the reported location information.

In some examples, the suggested next action may be a suggested message for the second user to send to the first user. For example, the second user may be presented with one or more preformulated messages to send to the first user in response to the first user's request for location information, such that the second user can select a message to send. The message may be, for example, an indication of the relative location of the second user, a note that the second user is running behind schedule or ahead of schedule, a question asking if they should pick anything up along the way, etc. According to some examples, instead of the second user using the suggested messages, the second user may generate their own message to send to the first user. According to further examples, the preformulated messages may be generated using a machine learning model that is trained using prior communications from the second user to the first user. For example, if the first user requests the location information of the second user every weekday afternoon and the second user commonly responds with “Do you want me to pick up dinner on my way home?”, the system may recognize this pattern and begin to provide a prompt to the second user when location information is requested on weekday afternoons, the prompt asking if the second user wants to send that message.

In another example, the suggested next action may be an update to a navigation route. For example, the second user may use a navigation system to reach a destination location. Based on the request from the first user and the location information of the second user, an update to the navigation route may be the suggested next action. According to some examples, the first user may interact with the location information of the second user. For example, the first user may provide a response to the second user based on the location information of the second user. By way of example only, such a response may be a warning to use caution to avoid obstacles on a particular street, or an instruction to pick something or someone up on the way. In some examples, the response provided by the first user may be used to update a navigational route for the second user.

According to some examples, the suggested next action may be providing an update regarding a scheduled event. The second user may authorize access to one or more applications, such an e-mail or calendar application. The scheduled events may be based on calendar events or calendar invites, e-mails, etc. Providing an update regarding a scheduled event may include, for example, sending a notification to a restaurant that they will be arriving later than the reservation time, updating a calendar entry for a scheduled meeting, sending a message to all users in a scheduled meeting that they will be arriving earlier or later than planned, etc.

The suggested next action may be automatically determined. For example, the system may determine the next suggested action without user input. The suggested next action may be based on the received request for location information from the first user and the location information from the second user.

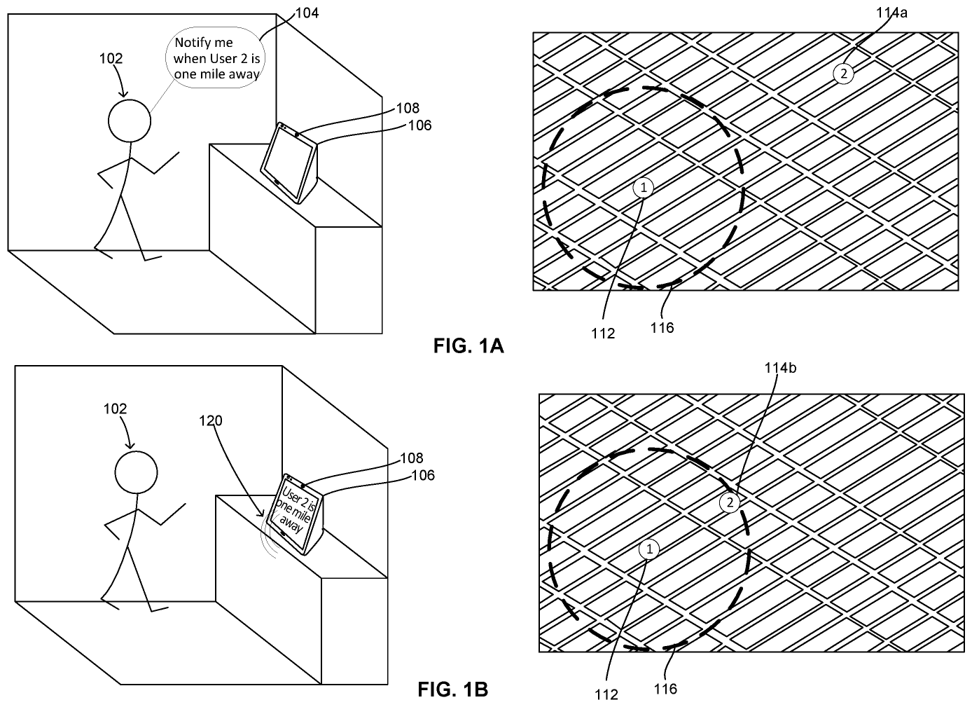

FIG. 1A illustrates an example request for a notification based on a trigger condition. The first user 102 may initiate a request 104 to receive a notification based on location information of a second user. The request 104 may be captured by one or more inputs of first user device 106, such as a microphone 108, camera, keyboard, touch screen, etc. The request 104 may be to receive a notification when the second user is one mile away. The request may be made through a mapping application, a home assistant, a device assistant, etc.

According to some examples, the second user may initiate location sharing with the first user. For example, the second user may initiate a request for the first user to receive a notification based on the location information of the second user. Additionally or alternatively, the second user may initiate a location sharing request to share their location information with the first user based on context. The context may include, for example, day, time, location of the first and/or second user, recent communications, scheduled events, or any other circumstances. Other information defining the context may include, for example, conditions such as weather, traffic, scheduled events, nearby points of interest, shopping lists, to-do lists, etc. For purposes of clarity and not as a limitation, the examples provided herein are based on the first user initiating the request.

The system may use automatic speech recognition to convert the request 104 into text. In some examples, the system may use a natural language understanding model to translate the converted text into a representation that provides an indication of the specific intent and parameters of the request 104. For example, the system may convert the text into a structure other than free form text. The intent may be, for example, what the first user seeks to achieve by asking the request 104. The parameters may be, for example, conditions under which to fulfill the request. For example, for a request that states “notify me when the second user is one mile away,” the intent may be to receive a notification when the second user is close, and the parameter may be that. the second user is one mile away. The identified parameters may be used to set the trigger condition for reporting location information. Continuing the example of the request to “notify me when the second user is one mile away” the trigger condition may be that the second user is one mile away. When the trigger condition is detected, a notification is sent to the first user reporting the location information of the second user i.

According to some examples, the intent, parameters, and trigger condition may be automatically determined. The intent, parameters, and trigger condition may be determined based on historical requests and/or the context of the request. For example, the request 104 may be “let me know where the second user is.” The system may determine, based on historical requests from the first user regarding the second user, the intent, parameters, and trigger condition of the request. For example, if the first user historically asks “let me know when the second user is 10 minutes away” when the first and second user have a scheduled event together, the system may use such historical information to determine that the intent of the first user's request to “let me know where the second user is” is to receive a notification when the second user is ten minutes away from the event destination. The parameters in this example may be determined to be when the second user is ten minutes away. The identified parameters may be used to set the trigger condition such that the location of the second user is reported when the second user is ten minutes away from the destination location.

In some examples, where the intent, parameters, and trigger condition may be automatically determined based on the context of the request, the system may consider the day, time, location of the first and/or second user, recent communications, scheduled events, etc. For example, the first user may typically request location information regarding the second user around 5 pm Monday through Friday. For example, the first user may request to know “where is the second user?”. Based on the context of the request, e.g., that it occurs at around 5 pm Monday through Friday, the system may determine that the first user wants a notification when the second user leaves work. The system may determine that the intent is to know when the second user leaves work and the parameter is leaving the second user's work location. The identified parameter may be used to set the trigger condition.

The system may analyze the representation and parameter to determine whether the request is related to a request for location information of another user. If the system determines the request is related to a request for location information, the system may derive relevant parameters of the request. The parameters include an identification of the user(s) whose location is shared with the first user making the request and the trigger conditions defined by the request. According to some examples, the parameters may include a notification type, an identification of the device to transmit the notification to, a timing of the request, a condition under which to get location updates, a level of urgency of the request, etc.

Identification of the users whose location is shared with the first user may determine whether the first user is authorized to receive location information. The trigger conditions defined by the request may determine when the system reviews information of the second user, when to provide a notification to the first user, etc. The notification type may be an audio, visual, and/or haptic notification. An identification of the device to transmit the notification to may determine whether one or more devices are intended to receive the notification of the location information. For example, the system may identify the device that received the request for location information. In some examples, the system may identify another device, such as another device used by the first user.

As shown in FIG. 1A, the request 104 may be to receive a notification when the second user is one mile away from the first user 102. In this example, the trigger condition 116 for the notification is the second user reaching a location at a distance of one mile from the location 112 of the first user 102. Upon receiving the request 104, the system may verify that the second user has authorized location sharing with the first user before providing location information regarding the second user in response to the first user's query.

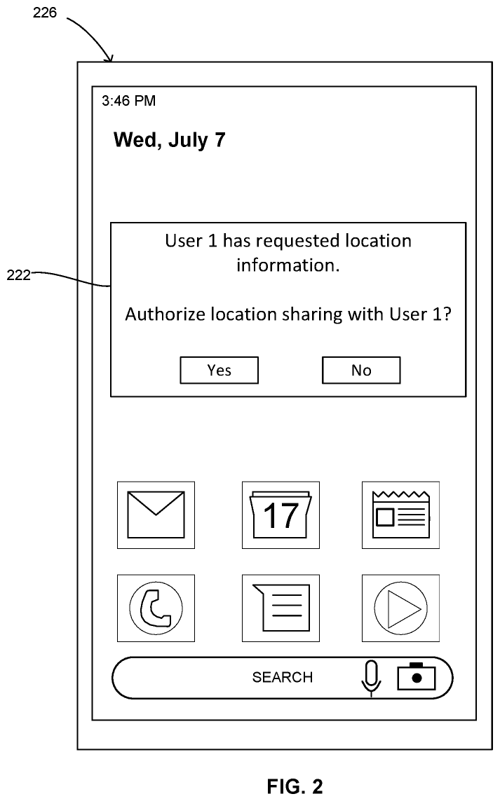

According to some examples, if the system determines that the second user has not authorized location sharing with the first user 102, the system may transmit a notification to the second user, as shown in FIG. 2 and discussed below. Additionally or alternatively, if the system determines that the second user has not authorized location sharing with the first user 102, the system may transmit an error notification to the first user 102. The error notification may provide an indication that the second user has not shared their location information with the first user 102. In some examples, the error notification may ask the first user 102 if the system should send a request to the second user to share their location information.

After verifying that the second user has authorized location sharing, the system may verify that the second user has authorized the use of data from one or more sensors of the second user's device to be used as part of the location sharing.

According to some examples, the system may receive data from the second user's device that corresponds to the first user's request 104. For example, upon receiving the first user's request 104, the system may transmit the trigger condition to the second user's device. In some examples, upon receiving the first user's request 104, the system may transmit a request for location information to the second user's device. The trigger condition and/or request for location information may indicate when the second user's device is to transmit location information to the system. The system may receive data from the second user's device upon the occurrence of the trigger condition. As shown, the system may receive data from the second user's device when the location 114b of the second user substantially corresponds to the trigger condition 116.

In some examples, the system may review cached data from one or more sensors of the second user's device to determine if the trigger condition 116 has occurred. The cached data may be data that has been previously transmitted to the system. The cached data may include, for example, location information. In examples where the cached location 114a of the second user indicates that the trigger condition 116 has occurred, the system may transmit a notification to the first user. The notification may be responsive to the first user's request 104. In examples where the cached location 114a of the second user indicates that the trigger condition 116 has not occurred, as shown in FIG. 1A, the system may request updated location information from the second user to determine whether the trigger condition 116 has been met since the system last received location information.

According to some examples, the system may receive location information from the device of the second user when the trigger condition 116 is met. For example, instead of continually receiving location information from the device of the second user until the trigger condition has been met, the system may only receive location information from the device of the second user when the trigger condition is met.

FIG. 1B illustrates an example notification based on the occurrence of a trigger condition. Continuing the example above, the first user's request 104 is to receive a notification when the second user is one mile away. Based on location information of the second user, the system may determine the location 114b of the second user fulfills the trigger condition. As shown, the location 114b of the second user may be at the trigger condition 116, which is a one mile radius around the location 112 of the first user. After determining that the trigger condition 116 has been met, the system may transmit a notification 120 to the first user. The system may transmit the notification 120 to the user device that captured the request 104. In some examples, the system may, additionally or alternatively, transmit the notification to other devices being used by the first user 102 or connected to first user device 106. The first user device 106 may output the notification 120 audibly via speakers, visually via the display, or both.

The use of trigger conditions may negate the need for the second user to consistently transmit their location or activity information and the first user to constantly poll for an updated location of the second user. In some examples, the use of trigger conditions may reduce the frequency in location updates provided by the second user to the system or from the system to the first user. Additionally or alternatively, limiting reporting to the trigger condition may reduce consumption of battery power and/or computational resources while preserving the quality of the location information. According to some examples, the system may automatically disable location sharing between the first user and the second user after the trigger condition is met. As such, a very accurate and efficient indication of the second user's location is provided by using a trigger condition which triggers only when the second user is confirmed to be at the triggering location. As mentioned above, the first user is thus provided with an accurate location of the second user while minimizing the use of bandwidth and computational resources.

While the request 104 illustrated in FIGS. 1A and 1B is to be notified when the second user is a certain distance away from the first user 102, the request may be to receive a notification for location information. For example, the request may be to receive a notification when the second user leaves a location, such as their office, or when the second user reaches a certain road, such as a highway. In some examples, the request may be based on time, such as when the second user is ten minutes away. Additionally or alternatively, the request may be based on the completion of an activity.

When the request is to receive a notification when the second user leaves their office, the trigger condition may be when the second user's location transitions from being at their office to no longer being at their office. In the example where the request is to receive a notification when the second user reaches the highway, the trigger condition may be when the second user is on the highway. In such an example, the system may review cached location information to determine whether the cached location information includes the second user being on the highway. If the cached location information does not indicate that the second user has met the trigger condition, the system may request to receive location information from the second user when the second user meets the trigger condition. By reviewing the cached data before requesting location information for the second user, the system may conserve bandwidth that would otherwise be consumed in requesting and receiving the location information

In some examples, the first user may request a notification based on the activity of the second user. For example, the first user may request to be notified when the second user completes their morning run, when the second user has gotten off the train, etc. In such examples, the system may review sensor data from the device of the second user to determine whether the trigger condition has been met. For example, the system may review data from the accelerometer of the second user's device to determine when the run has been completed or when the second user is no longer moving on a train. In some examples, the system may review data from a light sensor to determine whether the device is inside, outside, on a train or bus, etc. Upon detecting the trigger condition, the system may transmit a notification to the first user.

According to some examples, the first user 102 may initiate a query regarding the current location of the second user. For example, the query may be “Is the first user on the freeway?”. “how far away is the first user”, or “where is the first user?” Similar to when the system requests a request 104, the system may determine the query is for a general location of the user. The system may parse through cached location information 114a of the second user to determine whether there is enough information to answer the first user's 102 query. If yes, the system may provide a response to the first user. For example, in response to “Is the first user on the freeway?”, the system may provide a “yes” or “no.” In response to “where is the first user”, the system may provide a general location, such as the name of a neighborhood, the name of the road the first user is traveling on, etc.

In examples where the cached location information 114a of the second user cannot provide an answer to the first user's query, the system may request updated location information 114b from the device of the second user. For example the cached location information 114a may not be able to provide an answer to the query when the location information has not been updated within a predetermined period of time, such as one hour, six hours, one day, etc. The system may use the updated location information 114b to provide a response to the first user 102.

FIG. 2 illustrates an example notification requesting authorization to share location information. Referring back to the example in FIGS. 1A and 1B, the first user 102 may request 104 a notification when the second user is one mile away. In response to receiving the request 104, the system may verify whether the second user has shared location information with the first user 102. In examples where the system determines that the second user has not shared location information with the first user, the system may transmit a location sharing request 222 to the device 226 of the second user. The location sharing request 222 may identify the user making the request, e.g., the first user, and options for the second user to approve or deny the request. As shown, the location sharing request 222 may be output visually by device 226. In some examples, the location sharing request 222 may, additionally or alternatively, be output audibly. For example, if the second user is driving, the location sharing request 222 may be output audibly by device 226 to reduce distractions while the second user is driving.

According to some examples, the location sharing request 222 may include additional options delineating the parameters of location sharing. For example, the second user may authorize location sharing with the first user 102 for a predefined period of time, such as a day, week, month, year, etc. In some examples, the second user may authorize location sharing for a specific trip, such as the trip for the second user to meet the first user 102.

The device 226 may receive an input corresponding to a response to the location sharing request 222. For example, the device 226 may capture a voice command or may receive a touch input from the second user authorizing location sharing with the first user 102. After the system receives the authorization, the system may provide a notification to the first user 102 in response to the first user's request, as shown in FIG. 1B.

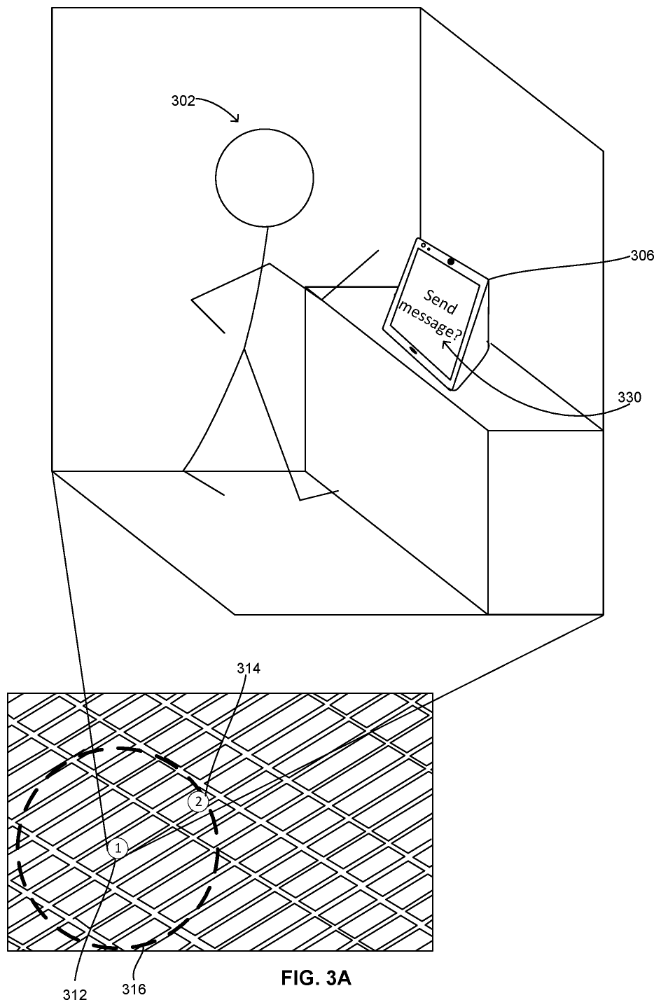

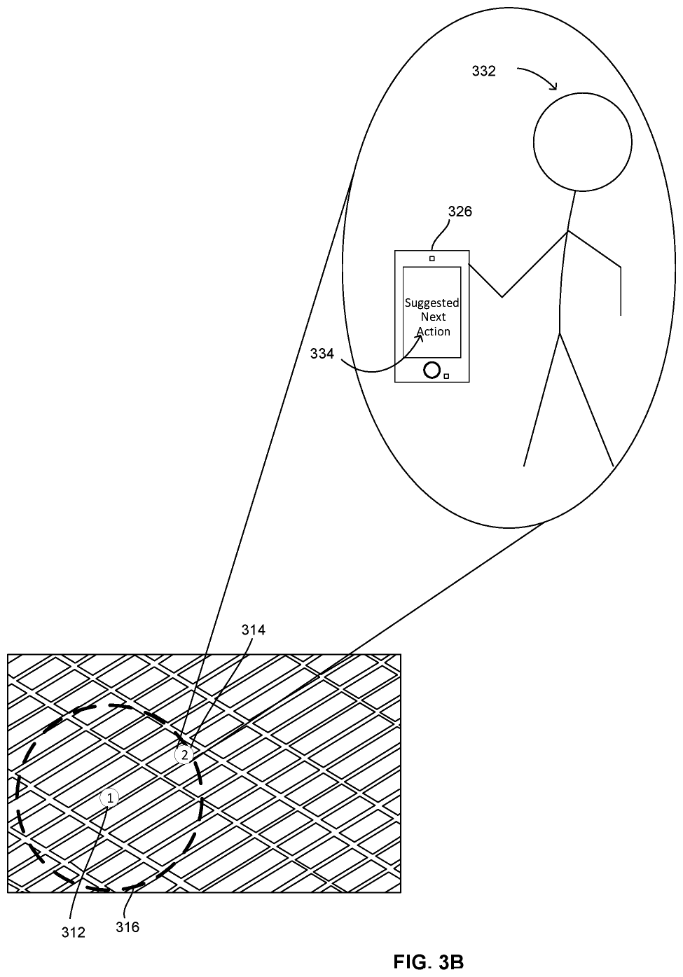

FIGS. 3A and 3B illustrate examples in which the system may suggest a next action. The suggested next action may be based on the request for location information from the first user and the location information of the second user. The system may suggest a next action to the first user, the second user, or both.

FIG. 3A illustrates a suggested next action transmitted to the first user 302. For example, the first user 302 may have initiated a request for location information for the second user. The request for location information may include a trigger condition 316, such as when the second user is a certain distance away from the location 312 of the first user 302. After verifying that the second user has authorized location sharing, the system may determine the location 314 of the second user. According to some examples, the system may parse cached location information of the second user to determine the location 314 of the second user. In some examples, the system may receive location information from the device of the second user when the trigger condition 316 is met.

Based on the request for location information from the first user 302 and the location 314 of the second user, the system may suggest a next action 330 to the first user 302. The system may transmit the suggested next action 330 to the device 306 that captured the request for location information. In some examples, the system may transmit the suggested next action to a different device that is connected to device 306 via a network or a device that is currently being used by first user 302.

The suggested next action 330 may be to send a message to the second user. According to some examples, the message may include one or more preformulated messages from which the first user 302 can select to send to the second user. The preformulated messages may state, for example, that the first user 302 is looking forward to seeing the second user soon, that the door is open for the second user to come in when they arrive, parking directions, or any of a variety of other possible messages. In some examples, the preformulated messages may be generated using a machine learning model that is trained using historical communications between the first user and the second user. For example, the preformulated messages may include several of the most common communications sent from the first user to the second user. According to further examples, the machine learning model may be trained using context, such the preformulated messages suggested to the first user may vary depending on context. Such context can include, for example, day, time, location of the first and/or second user, recent communications, scheduled events, or any other circumstances. In some examples, instead of the first user 302 using the suggested messages, the first user 302 may generate their own message to send to the second user.

According to some examples, the suggested message may relate to the location information of the second user. For example, the first user 302 may generate a message based on the location information of the second user. In examples where the request for location information is to receive a notification when the second user is ten minutes away, the generated message may be, for example, a warning regarding construction nearby the location of the second user.

FIG. 3B illustrates a suggested next action transmitted to a device 326 of the second user 332. The suggested next action 334 may be based on context. For example, the context may include the request for location information from the first user 302 and the location 314 of the second user 332. For example, parameters of the request may include information identifying the second user, the type of notification, a timing of the request, the trigger conditions defined by the request, etc. Such parameters, in combination with location of the second user or other information, may define the context upon which the suggested next action is based. Other information defining the context may include, for example, conditions such as date, time, weather, traffic, scheduled events, nearby points of interest, shopping lists, to-do lists, etc.

The suggested next action 334 for the second user 332 may be, for example, an update to the navigation route, sending a message to the first user 302 or another user, updating a scheduled event, etc. According to some examples, the suggested next action 334 may be a suggested message to send from the second user 332 to the first user 302, such as an indication that the second user 332 is running late, is stuck in traffic, is going to arrive early, etc. Similar to the suggested next action for the first user described above, the suggested next action for the second user 332 may include one or more preformulated messages that may be generated using a machine learning model.

When the second user 332 authorizes the system to access one or more applications, such as an e-mail or calendar application, information from such applications may be used to formulate the suggested next action. For example, the system may identify one or more scheduled events based on calendar events or calendar invites, e-mails, etc. In some examples, the system may identify other users attending the scheduled events or a destination location of the scheduled event. For example, if the scheduled event is a reservation at a restaurant, the system may suggest a message to be sent from the second user 332 to the restaurant, the message indicating that they will be late for their reservation. In some examples, the system may suggest sending an update to the scheduled event to the other users attending the event. According to some examples, instead of the second user 332 using the suggested messages, the second user 332 may generate their own message and identify the message recipient.

While one user device 326 is illustrated in FIG. 3B, the system may transmit the suggested next action to any of a number of user devices associated with the second user 332. For example, if the second user 332 is driving a car, the system may transmit the suggested next action 334 to device 326 and the car. In some examples, if the second user is riding a motorcycle, the system may transmit the suggested next action 334 to device 326 and a smart helmet being worn by the second user 332. While the second user device 326 is illustrated as a smart phone, it may be any of a numerous possible types of user devices, such as a smart watch, smart helmet, AR/VR headset, smart car, gaming console, etc.

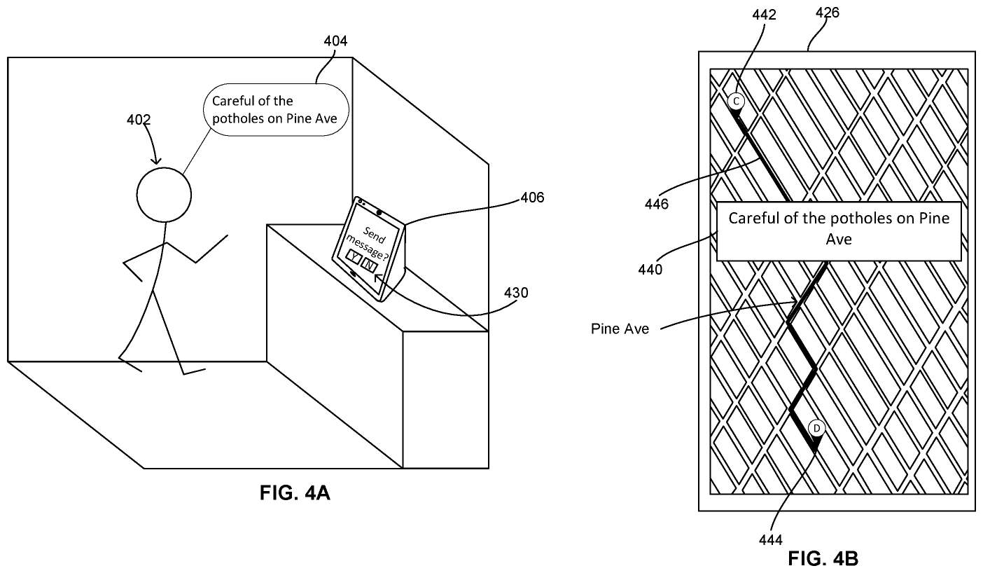

FIGS. 4A-8B illustrate a few examples of a number of possible use cases for the system described herein, wherein location reporting is based on a trigger condition and generates a context-based suggested next action.

FIGS. 4A-4B illustrate an example in which the first user 402 requested to receive a notification based on the location information of the second user, and suggested next action 430 prompts the first user 402 to send a communication to the second user. The suggested next action 430 is based on the request from the first user 402 and the location information of the second user, is sent to first user device 406. The next suggested action 430 may be provided after a trigger condition has been met, wherein the trigger condition may be defined by the first user's request. In this example, the trigger condition is when the second user reaches a particular location.

According to some examples, the system may provide the next suggested action 430 to the first user 402 before the trigger condition is met. For example, the system may transmit the next suggested action 430 to the first user device 406 before transmitting the notification based on the location information of the second user.

The next suggested action 430 may be a suggested message. The suggested message may be a preset message or a user generated message. For example, the first user 402 may generate a message providing information 404, such as a warning or relevant information associated with the location information of the second user, to be transmitted to the second user.

The next suggested action 430 may allow the first user 402 to interact with the location information provided. For example, based on the location information provided in response to the request, the next suggested action 430 may be to send information 404 from the first user 402 destined for the second user. According to some examples, the information 404 in the message may be relevant to the second user's current location. For example, the first user device 406 may capture audio input from the first user 402 advising the second user to be careful of the potholes on Pine Avenue, which may be along the navigational route of the second user. The system may transmit the information to the device 426 of the second user, as shown in FIG. 4B.

FIG. 4B illustrates an example output at a second user device of the information provided by the first user 402. In examples where the second user is traveling along a navigation route, the second user device 426 may execute a mapping application that provides maps or directions. The mapping application may provide an indication of the second user's current location 442, destination location 444, and navigation route 446. The information 404 from the first user may be output as a notification 440 at the second user device 426. For example, the notification 440 may be provided as an overlay on a map rendered using the display of the second user device 426. In some examples, notification 440 may, additionally or alternatively, be provided output audibly to minimize distractions while driving.

According to some examples, the information 404 provided by the first user 402 may be transmitted to the second user for immediate output. In some examples, the notification 440 may be output when there is a lull between navigation instructions in a sequence of instructions. In yet another example, the system may delay transmitting the notification 440 to the second user for output until a relevant time. Continuing the example, the system may delay transmitting the notification 440 to the second user until the location of the second user is closer to a specified location, such as the location of Pine Ave specified in the information 404.

According to some examples, the system may delay transmitting the information until the second user is within a threshold distance from the specified location. For example, if the user is a substantial distance or traveling time away from Pine Ave, the system may delay transmission of the notification 440 until the second user is within 2 miles of Pine Ave. Such threshold distance may be varied, and/or may be modified by the first user or the second user. By delaying the transmission of the notification until the user is within a threshold distance from the specified location, the second user's receipt of the notification is received at a time that is most relevant to the current navigation of the user. Such a timing not only ensures that the notification is provided at the most relevant time to be actioned by the second user, but also improves navigation safety by reducing unnecessary distraction which could occur were the second user to be provided with the notification at an earlier time.

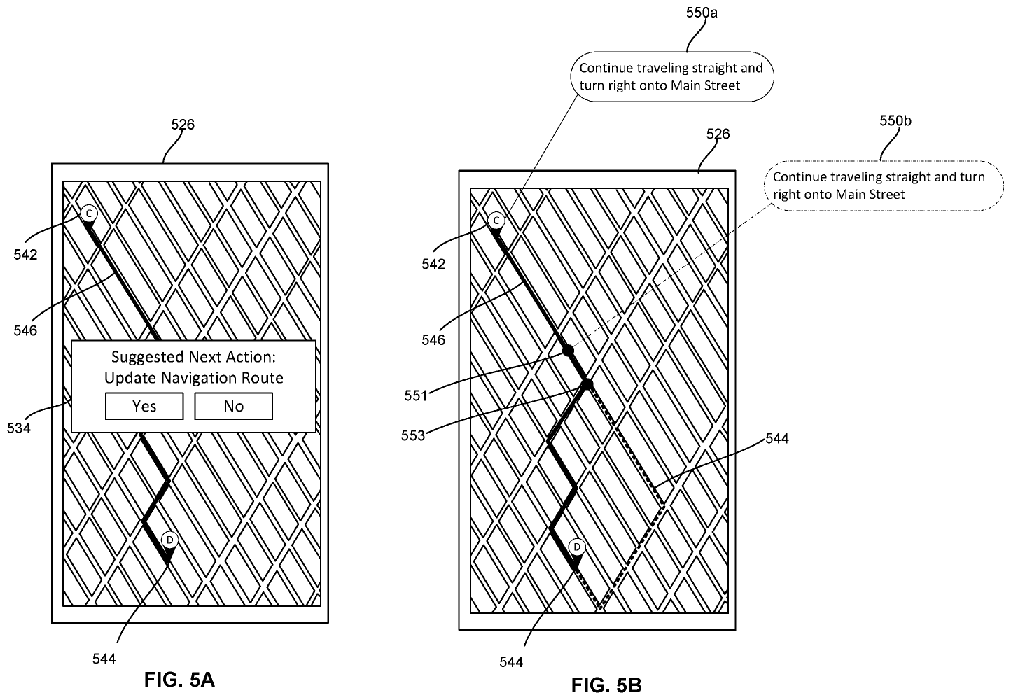

FIGS. 5A-5B illustrates an example in which the system may suggest a next action to the second user. For example, the device 526 of the second user may execute a mapping application. The mapping application may provide a navigation route 546 from the second user's current location 542 to a destination location 544.

The system may receive a request from the first user for location information associated with the second user. Based on the request and the location information of the second user, the system may suggest a next action 534 to the second user. For example, the suggested next action 534 may be to update the navigation route. Continuing with the example of FIGS. 4A and 4B, if the first user provides information to the second user to be careful of the potholes on Pine Avenue, the suggested next action 534 may be to update the navigation route to avoid Pine Avenue.

As shown, the suggested next action 534 may be output as an overlay on a map rendered using the display of the device 526 of the second user. In some examples, such as when the second user is driving, the suggested next action 534 may be output as an audible notification. The system may receive an input responsive to the suggested next action, such as a verbal command or touch input, corresponding to a selection of “yes” or “no”. In examples where the system receives an input corresponding to yes, the system may update the navigation route. According to some examples, the system may automatically update the navigation route as the next suggested action without receiving user input. For example, the second user may define settings of the second user device authorizing automatic updates. Such settings may specify parameters for which automatic updates are authorized, such as updates from a specified user, updates related to navigation, updates within a specified geographical region, updates during a specified time period, etc. By automatically updating the navigation route of the second user, such as based on a response from the first user, improved navigation is provided as the navigation route automatically updates to take the response into account. Such a navigation route may therefore be faster, cheaper, and/or safer based on the automatic update.

FIG. 5B is an example illustrating various times when the suggested next action to update a navigation route may be provided to the second user. The next suggested action may be provided for output to the second user almost immediately after the system determines the next suggested action is to update the navigation route. In some examples, the output may be delayed to a more relevant time, such as when the second user travels within a predetermined distance of a point 553 along the navigation route 546 at which the original route diverges from the updated route. In some examples, the suggested next action may be provided at multiple times and/or points along the navigation route 546.

In examples where the update is output almost immediately after the system determines to update the navigation route, the system may output the update 550a regardless of the second user's current location 542. For example, the system may determine the next suggested action is to update the navigation route when the second user is at location 542. The system may output the next step of the navigation route at the second user's current location 542.

In some examples, the update 550b to the navigation route may be output once the second user is within a threshold distance from the update to the navigation route. As shown in FIG. 5B, the update to the navigation route 546 may be at location 553. At location 553, the update may be, for example, for the second user to continue traveling straight instead of turning right onto Pine Avenue. In such an example, the update 550b to the navigation route may be output to the second user when the second user is five hundred feet from Pine Avenue, such as location 551 along navigation route 546. However, the threshold distance may be more or less than five hundred feet. In some examples, the threshold distance may be set by the user based.

In some examples, in addition or alternative to the threshold distance, the update 550b to the navigation route 546 may be output when the second user is within a threshold travel time from the update. For example, the update 550b to the navigation route may be output when the second user is thirty seconds away from update. In such an example, the typical travel time between location 551 and location 553 may be thirty seconds. The threshold travel time may, however, be more or less than thirty seconds. In some examples, the threshold travel time between when the update is received and the update to the navigation route may be set by the user.

By delaying the output of the update 550b to a more relevant time, such as when the second user is closer to the location within the update, the second user may be able to respond to the update more appropriately. For example, by providing update 550b within the threshold distance from the update, or change, in the navigation route, the second user may be more prepared for the updated next step in the navigation route.

The update 550a, 550b may be provided audibly and/or visually. For example, the update 550a, 550b may be output via one or more speakers of the device 526. In some examples, the update 550a, 550b may be output as an overlay or pop-up on the display of device 526. In some examples, the update 550a, 550b may be output in a designated portion of the display in the mapping application.

In some examples, the suggested next action 534 and/or updates 550a, 550b may be interleaved into the navigation audio of navigation route 546. For example, the suggested next action 534 may be provided at a time between navigational instructions for navigation route 546. In some examples, updates 550a, 550b may be provided at a time between navigation instructions for navigation route 546. By interleaving the suggested next action 534 and/or updates 550a, 550b into the navigational instructions for route 546, the system may avoid disrupting the current navigation route 546 for the second user. This may reduce distractions as the second user drives along navigation route 546.

According to some examples, the update to the navigation route may be based on the request from the first user and the location information of the second user. For example, if the first user requests a notification when the second user is ten minutes away, when the trigger condition is met, e.g., when the second user is ten minutes away, the update to the navigation route may modify an existing route to an alternative route to reach the destination location. In some examples, the update to the navigation route may, additionally or alternatively, be based on the information provided by the first user, as illustrated in FIGS. 4A and 4B. For example, the update 550a, 550b to the navigation route may be to “Avoid Pine Avenue. Continue traveling straight and turn right onto Main Street.” The update to the navigation route may, therefore, cause the second user to avoid the pot holes on Pine Avenue, as cautioned by the first user.

Allowing the first user to interact with the location information of the second user may allow the first user to be an active participant in the navigation session of the second user. For example, the first user may be alerted to any delays in the second user's navigation, arrival times, etc. The first user may, in some examples, be able to alert the second user of dangers or potential delays. More generally speaking, the first user may, as a response, provide navigation information to alter the existing navigation route of the second user. Such navigation information, when received by the second user, may cause an automatic update of the navigation route based on the navigation information. Such an automatic update may thus result in a navigation route that takes the navigation information from the first user into account. The provided navigation information from the first user may include an instruction to alter and improve the navigation route, such an instruction identifying an issue affecting, for example, the speed, duration and/or safety of the navigation route. Such an instruction may be explicit (e.g. “Avoid Pine Avenue” or “Continue traveling straight and turn right onto Main Street”), or implicit (e.g. “be careful of the potholes on Pine Avenue”). By automatically updating the navigation route in this manner, the resultant navigation route is safer and/or more efficient as navigation information from the first user is taken into account.

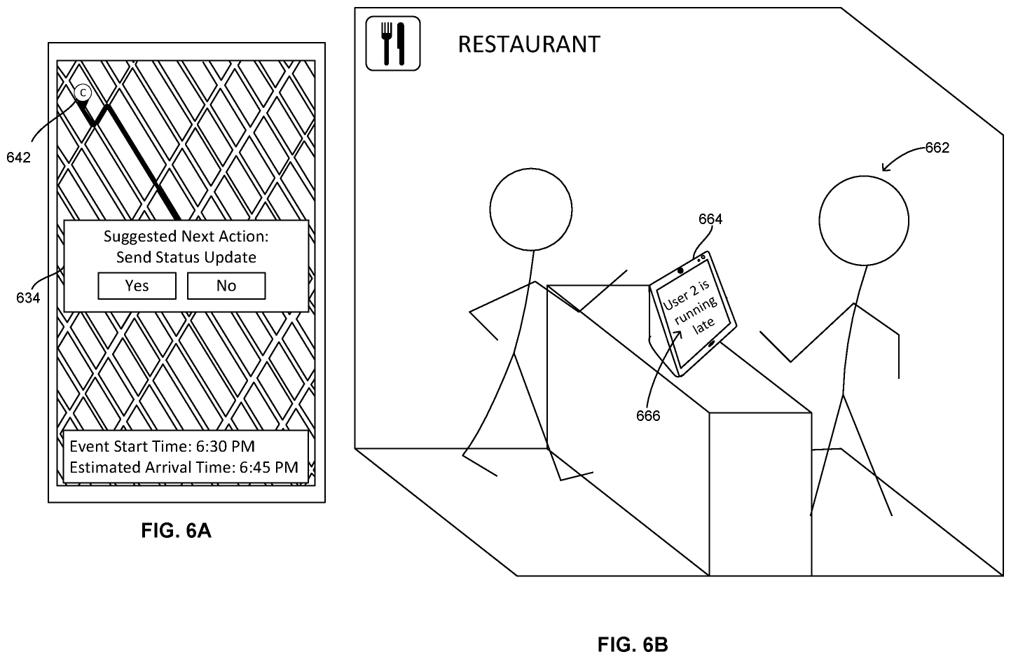

FIGS. 6A-6B illustrate an example use case in which the suggested next action prompts a communication to a third party.

The communication may include a status update based on the location of the second user. For example, the second user may authorize access to one or more applications, such as an e-mail or calendar applications. The system may identify one or more scheduled events based on calendar events or calendar invites, e-mails, etc. In one example, the system may compare the location information of the second user to the event location. Based on a difference in the start time of the scheduled event and the estimated arrival time of the second user, the system may determine to send the status update. For example, the status update may be that the second user is in traffic and will arrive at the scheduled event ten minutes later than planned. In some examples, the status update may be that the second user will arrive earlier than planned. By way of example, the scheduled event may be a dinner reservation for 6:30 PM at a given restaurant. The system may compare the current location 642 of the second user with an event location of the scheduled event, and determine an estimated arrival time of the second user to the event location. As shown in FIG. 6A, the event start time is 6:30 PM and the estimated arrival time is 6:45 PM. Based on the difference between the start time and the estimated arrival time, the system may suggest a next action 634.

The suggested next action 634 may be to send a status update. According to some examples, the status update may be based on the difference between the start time of the scheduled event and the estimated arrival time of the second user at the scheduled event. For example, as shown in FIG. 6A, the second user is estimated to arrive at the event fifteen (15) minutes later than the start time. The system may suggest next action 634 to the second user to send a status update indicating that the second user is running late. The status update may be a suggested message, such as “running late.” In some examples, the second user may generate their own message to send, such as “do not wait for me to start” or “hold my reservation.” The status update may be sent automatically, without input from the second user.

The system may transmit the status update from the second user to a third party 662. For example, as shown in FIG. 6B, the system may transmit status update 666 to a device 664 at the event location. In this example, the device 664 may be a communication device operated by a host or server or manager of the restaurant. The third user 662 may be able to use this information to hold the reservation, inform other users attending the scheduled event, etc.

According to some examples, the system may, additionally or alternatively, transmit the status update to the first user. In some examples, the system may transmit the status update to all users listed on or associated with the scheduled event.

According to some examples, the second user may select which users should receive the status update. For example, when suggesting the next action 634, the system may provide a list of relevant users. The list of relevant users may be based on the identified users attending the scheduled event. In some examples, the list of relevant users may include the contact for the location of the scheduled event.

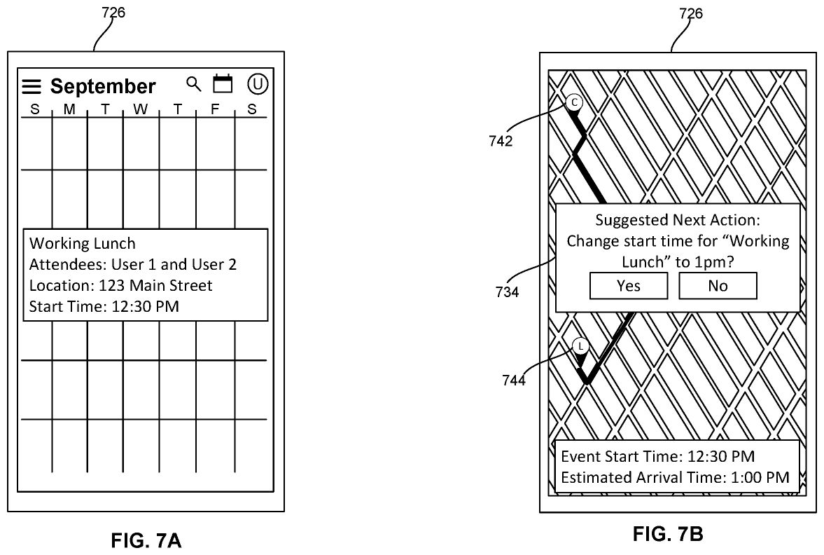

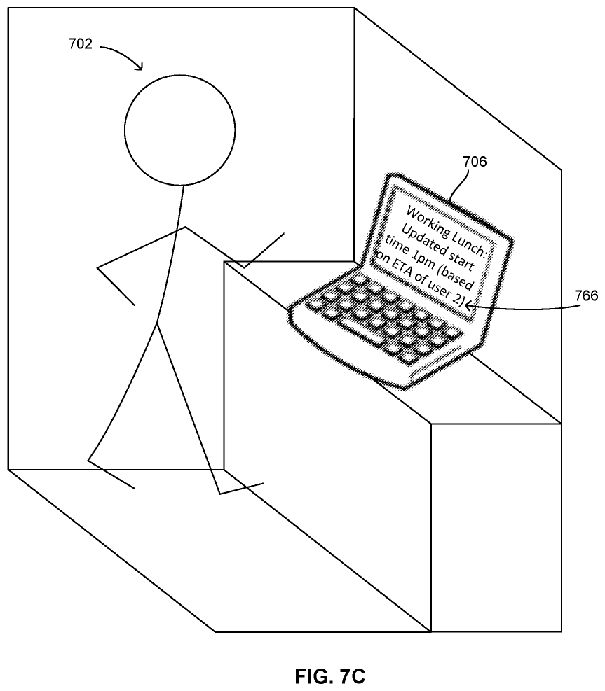

FIGS. 7A-7C illustrate another example in which the system may suggest a next suggested action to the second user. The next suggested action may be to send a notification updating the day, time, and/or location of a scheduled event.

FIG. 7A illustrates an example of a scheduled event. After receiving authorization from the second user to access one or more applications, such as an e-mail, messaging, social media, or calendar application, the system may identify one or more scheduled events. For example, the system may determine that the second user has a working lunch planned with the first user at 12:30 PM at 123 Main Street. The system may identify the start time of the scheduled event as 12:30 PM and the location of the scheduled event to be 123 Main Street.

As shown in FIG. 7B, the device 726 of the second user may execute a mapping application to provide a navigation route between the current location 742 of the second user and the event location 744. Based on the current location 742 of the second user and the event location 744, the mapping application and/or system may determine an estimated arrival time for the second user to arrive at the event location 744.

The system may compare the event start time, 12:30 PM, to the estimated arrival time, 1:00 PM. Based on the comparison, the system may suggest a next action 734 to the second user. The suggested next action 734 may be to send a message to the users attending the scheduled event. For example, the system may suggest a message based on the comparison of the event start time and the estimated arrival time. For example, the suggested message may indicate the estimated arrival time, a proposed update to the meeting time in the calendar entry, suggesting a different meeting location based on traffic conditions, etc. In some examples, instead of using the suggested messages, the second user may generate their own message destined for the first user.

The system may provide the suggested next action 734 for output on the second user's device 726. The system may provide the suggested next action 734 as an overlay on the display of device 726, audibly, as a notification that the second user can opt to open, or any combination of the above. As shown, the next suggested action 734 may be to change the start time for the scheduled “working lunch” to 1:00 PM. The system may receive an input corresponding to a selection of yes or no in response to the suggested next action 734. For example, the system and/or device 726 may receive a tactile and/or audible input corresponding to a selection of yes or no.

In examples where the system receives a selection corresponding to yes, the system may transmit a message to the users associated with the scheduled event. For example, the system, after receiving authorization from the second user or automatically without input form the second user, may identify the users attending the scheduled event based on contact information in e-mails or on a calendar event or invite and/or a contact for the location of the scheduled event. The system may transmit the event update to the identified users.

FIG. 7C illustrates an example event update transmitted to the identified users. For example, the system may identify, based on the calendar entry in the second user's calendar, that the first user 702 is attending the working lunch with the second user. The system may transmit the event update 766 to device 706 of the first user 702. The event update 766 may include a change in time, day, location, etc. based on the first user's request for location information and the second user's location information.

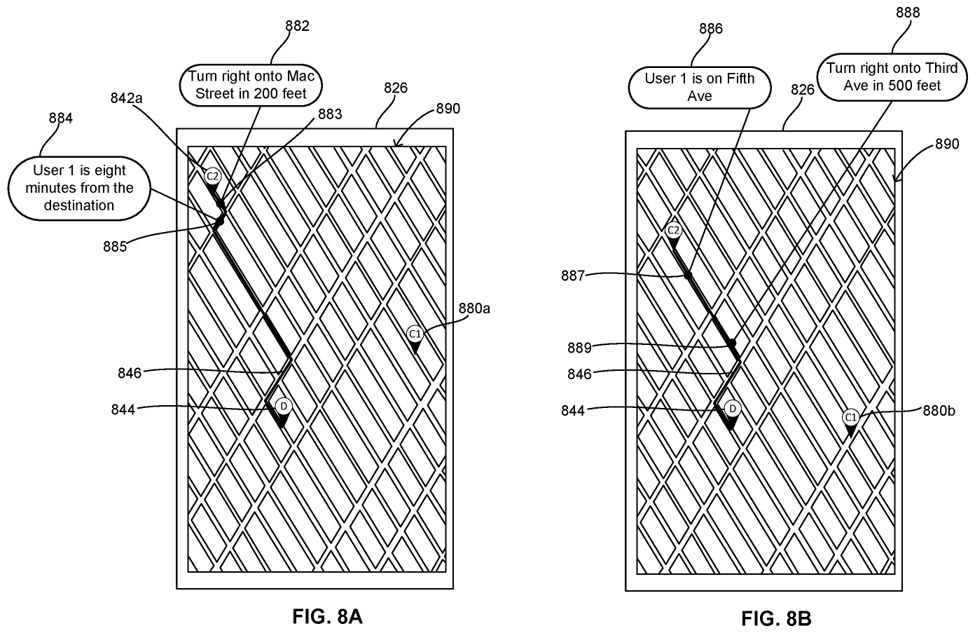

FIGS. 8A-B illustrate an example where the first and second users may have plans to meet at a point of interest. For example, after verifying that the first and second user have authorized access to one or more applications, the system may determine that the first and second users have plans to meet for dinner based on a calendar entry, email, etc. The system may, after verifying that the first user has authorized location sharing with the second user and that the first and second user are both attending the same scheduled event, provide the second user with location updates of the first user's location. According to some examples, based on the location updates, the system may provide a suggested next action to the first and/or second user, such as the suggested next actions discussed above with respect to FIGS. 4A-7C.

As shown in FIGS. 8A and 8B, second user device 826 displays navigation instructions for traveling between an origin and the point of interest, such as destination 844. The origin may be the second user's current location 842a. The navigation instructions include a navigation route 846. The navigation route 846 may be provided visually on a map 890, which also depicts the first user's current location 880a. In some examples, in addition to or as an alternative, navigation instructions may be provided audibly such that the second user does not have to take their attention off the road as they are driving. For example, as shown in FIG. 8A, the navigation system may output, audibly, visually, or both, instruction 882, indicating that the second user should turn right onto Mac Street in two hundred (200) feet. In examples where the navigation instructions are audible, audible location updates may be interleaved with the instructions.

As shown in FIG. 8A, first instruction 882 for navigating to the destination 844 may be output by the second user device 826 when the second user reaches point 883 along navigation route 846. Location update 884, indicating first user's current location 880a, may be output by the second user device 826 after the first instruction 882 is output and before a second navigation instruction is provided to the second user. For example, location update 884 may be output when the second user reaches point 885 along navigation route 846. Location update 884 may, therefore, be interleaved between the first and second navigation instructions.

As shown in FIG. 8B, a second location update 886, indicating an updated location 880b of the first user, may be provided to the second user. The second location update 886 may include update information associated with the location information of the second user different than the first location update 884. For example, the second location update 886 may indicate that the first user is on Fifth Avenue. In some examples, the second location 886 may indicate an estimated time of arrival. The second location update 886 may be provided between navigation instructions. For example, the second location update 886 may be provided when the second user reaches point 887 along navigation route 846. Subsequent navigation instruction 888 may be provided when the second user reaches point 889 along navigation route 846. The second location update 886 may, therefore, be interleaved between navigation instructions. Interleaving the location updates 884, 886 may, therefore, allow the second user to receive updates regarding the location of the first user without interfering with the steps of the navigation route, thereby improving navigation safety.

According to some examples, the updated location of the first user may be provided at a certain frequency. The frequency may be after based on distance, time, or both. In examples where the frequency is based on distance, the second user may receive location updates pertaining to the first user each time the first user travels a predetermined distance. For example, the second user may receive location updates each time the first user travels another mile, two miles, 500 feet, etc. along the route on their way to the destination. In examples where the frequency is based on time, the second user may receive location updates pertaining to the first user at a certain time interval, such as every three, five, ten, etc. minutes.

According to some examples, the frequency, whether time or distance, may be based on the amount of time or distance the first user is traveling to reach the destination. For example, if the first user has to travel a long distance, such as one hundred miles, to reach the destination, the frequency of updates may be less than when the first user has to travel a short distance, such as ten miles.

In some examples, the updated location of the first user may be provided based on a significant event. The significant event may be a traffic accident that has delayed the first user, whether the first user reaches a certain location along the navigation route, whether the user has gotten on or off public transportation, etc.

Based on the frequency and/or occurrence of significant events, the updated location of the first user may be provided to the second user. The updated location information may be interleaved into the navigation instructions for the second user. According to some examples, the system may suggest a next action based on the updated location information. For example, and as discussed above with respect to FIGS. 6A-7C, based on the updated location information, the system may determine that the first user is going to be late to the scheduled event. In such an example, the suggested next action may be to send a message to the destination indicating that the first user is going to be late, to reschedule the scheduled event to a later time, etc.

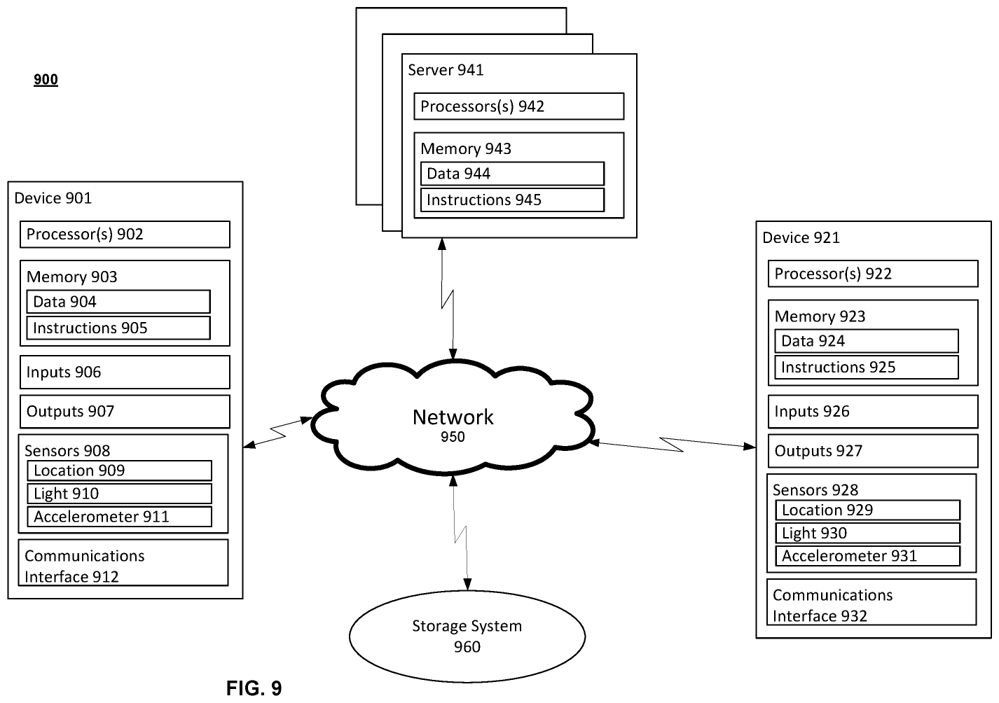

FIG. 9 illustrates an example system in which the features described above and herein may be implemented. It should not be considered limiting the scope of the disclosure or usefulness of the features described herein. In this example, system 900 may include devices 901, 921, servers 941, network 950, and storage system 960. For purposes of clarity, devices 901, 921 will be described with respect to device 901. However, it should be understood that device 921 may include the same or similar components and may function in substantially the same manner of device 901.

Device 901 may include one or more processors 902, memory 903, data 904 and instructions 905. Device 901 may also include inputs 906, outputs 907, sensors 908, and communication interface 912. The device 901 may, for example, a smart phone, tablet, laptop, smart watch, AR/VR headset, smart helmet, smart car, etc.

Memory 903 of device 901 may store information that is accessible by processor 902. Memory 903 may also include data that can be retrieved, manipulated or stored by the processor 902. The memory 903 may be of any type capable of storing information accessible by the processor 902, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. Memory 903 may store information that is accessible by the processors 902, including instructions 905 that may be executed by processors 902, and data 904.

Data 904 may be retrieved, stored or modified by processors 902 in accordance with instructions 905. For instance, although the present disclosure is not limited by a particular data structure, the data 904 may be stored in computer registers, in a relational database as a table having a plurality of different fields and records, XML documents, or flat files. The data 904 may also be formatted in a computer-readable format such as, but not limited to, binary values, ASCII or Unicode. By further way of example only, the data 904 may comprise information sufficient to identify the relevant information, such as numbers, descriptive text, proprietary codes, pointers, references to data stored in other memories (including other network locations) or information that is used by a function to calculate the relevant data.

The instructions 905 can be any set of instructions to be executed directly, such as machine code, or indirectly, such as scripts, by the processor 902. In that regard, the terms “instructions,” “application.” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 902 may include any conventional processors, such as a commercially available CPU or microprocessor. Alternatively, the processor can be a dedicated component such as an ASIC or other hardware-based processor. Although not necessary, device 901 may include specialized hardware components to perform specific computing functions faster or more efficiently.

Although FIG. 9 functionally illustrates the processor, memory, and other elements of device 901 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of the devices 901. Accordingly, references to a processor or device will be understood to include references to a collection of processors or devices or memories that may or may not operate in parallel.

Inputs 906 may be a mouse, keyboard, touch-screen, microphone, or any other type of input. The inputs may receive the user's authorization to access one or more applications to obtain information for scheduled events. The inputs may, additionally or alternatively, receive the user's authorization to access sensors 908 to obtain location information. For example, the user can select particular applications for which to allow location services, particular times during which location services can be enabled, or other permissions or limitations for the location services. According to some examples, inputs 906 may receive requests for location information and/or responses to received location information.

Outputs 907 may include a display or speakers. The display may be monitor having a screen, a touch-screen, a projector, or a television. The display of device 901 electronically display information to a user via a graphical user interface (“GUI”) or other types of user interfaces. For example, as will be discussed below, the display may electronically display a next suggested action for a user. The speakers may output notifications in response to a request for location information. In some examples, the speakers may output next suggested action audibly. Additionally or alternatively, the speakers may output interleaved audio such that a user may receive notifications associated with location information between steps of a navigation route.

Sensors 908 may include a location sensor 909, light sensor 910, motion sensors 911, pressure sensor, temperature sensor, humidity sensor, etc. The location sensor 909 may be, for example, a global positioning system (“GPS”) sensor, wireless communications interface, etc. The location sensor 909, when enabled by the user, may provide a rough indication as to the location of the device. According to some examples, when authorized by the user, the location sensors may provide location information that can be shared with other users. The motion sensors 911 may include gyroscopes or accelerometers. The location sensor 909 and/or motion sensor 911 ay be included to detect position and movement of the device 901.

The light sensor 910 may measure the illuminance or the amount of light received by device 901 in the environment the device 901 is operating in. The temperature sensors may determine the ambient air temperature and/or the device temperature. The pressure sensor may determine the ambient air pressure of the environment around the device. The humidity sensors may determine the ambient relative humidity of the environment. The system may use the sensor data to determine if a trigger condition has been met. In this regard, the system may detect a trigger condition that is based on environmental factors. For example, if the trigger condition is the completion of a workout, the system may review data from a light sensor of the user's device to determine when the user's device is no longer in a gym locker. If the trigger condition is whether the user has landed at their destination, the system may review data from a pressure sensor to determine when the user's device is no longer in a pressurized air cabin of an air plane.

The location information may be stored locally on the device 901 or navigational system, such as part of an application or integrated into a user's vehicle. In some examples, the location information may be shared to a remote location, such as a remote server 941 or storage system 960. According to some examples, the system may parse through the location information when determining whether a trigger condition has been met.

The device 901 may include a communications interface 912, such as an antenna, transceiver, and any other devices used for wireless communication. The communications interface 912 may transmit location information to a server and/or network when a trigger condition is met. In some examples, communications interface 912 may transmit and/or receive notifications, messages, next suggested actions, etc.

The devices 901 can be at various nodes of a network 950 and capable of directly and indirectly communicating with other nodes of network 950. Although two devices are depicted in FIG. 9, it should be appreciated that a typical system can include one or more devices, with each computing device being at a different node of network 950. The network 950 and intervening nodes described herein can be interconnected using various protocols and systems, such that the network can be part of the Internet, World Wide Web, specific intranets, wide area networks, or local networks. The network 950 can utilize standard communications protocols, such as WiFi, Bluetooth, 4G, 5G, etc., that are proprietary to one or more companies. Although certain advantages are obtained when information is transmitted or received as noted above, other aspects of the subject matter described herein are not limited to any particular manner of transmission.

In one example, system 900 may include one or more server computing devices 941 having a plurality of computing devices, e.g., a load balanced server farm, that exchange information with different nodes of a network for the purpose of receiving, processing and transmitting the data to and from other computing devices. For instance, one or more server computing devices 941 may be a web server that is capable of communicating with the one or more device 901 via the network 950. In addition, server computing device 941 may use network 950 to transmit and present information to a user of one of the other devices 901. Server computing device 941 may include one or more processors 942, memory 943, instructions 945, data 944, sensors, etc. These components operate in the same or similar fashion as those described above with respect to device 901.

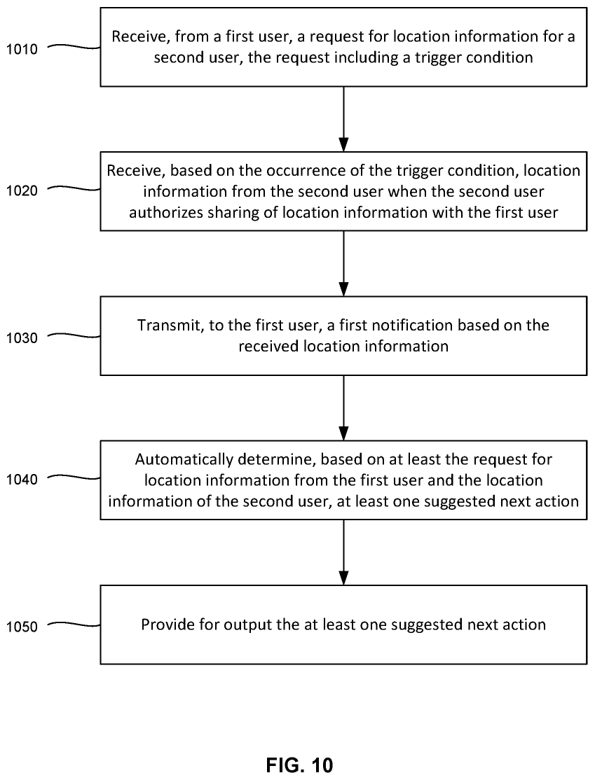

FIG. 10 illustrates an example method for reporting location based on detection of a trigger condition, and providing a context-based suggested next action. The following operations do not have to be performed in the precise order described below. Rather, various operations can be handled in a different order or simultaneously, and operations may be added or omitted.

In block 1010, the system may receive, from a first user, a request for location information for a second user, the request specifying a trigger condition. The trigger condition may be location specific, such as when the second user leaves a certain location, when the second user reaches a certain location, when the second user is a certain distance or amount of travel time away from a certain location, etc.

In block 1020, if the second user authorizes sharing of location information with the first user, the system may receive, based on the occurrence of the trigger condition, location information from the second user. By limiting location reporting from a device of the second user to instances in which the trigger condition is met, a frequency of transmission by the second user device is limited, thereby conserving network resources such as bandwidth. Moreover, resources such as power of the first user device are also conserved, as the first user device does not need to repeatedly poll for location information from the second user.

In block 1030, the system may transmit, to the first user, a first notification based on the received location information. The first notification may be a response to the request for location information. For example, the first notification may indicate to the first user that the trigger condition specified in the first user's request has been met.

In block 1040, the system may automatically determine, based on at least the request for location information from the first user and the location information of the second user, at least one next action, which may be a suggested next action. For example, the system may determine a context of the request. The context of the request may be based on parameters of the request, such as an identification of the user(s) whose location is shared with the first user, a timing of the request, a notification type, and identification of the device(s) to transmit the notification to, trigger conditions defined by the request, etc.

Referring to the example shown in FIGS. 4A-4B, the system may determine the next suggested action based on the request from the first user for a notification when the second user is ten minutes away and the location information of the second user. After the location information of the second user meets the trigger condition, e.g., when the second user is ten minutes away, the system may determine the suggested next action for the first user may be to send a message to the second user.

According to some examples, the system may use a trained machine learning (“ML”) model to determine the suggested next action. The ML model may be trained to determine suggested next actions based on context. For example, the ML model may be trained to determine a suggested next action based on parameters of the request for location information. For example, if the first user requests a notification when a user is ten minutes away from their house and, upon receiving the notification, the first user commonly provides a message to the user that the door is open, the system may recognize this pattern based on the context of the request, e.g., to be notified when someone is ten minutes away, and begin to provide a prompt to the first user when the first user requests location information relative to an arrival time, the prompt asking if the first user wants to send that message.

In some examples, the ML model may be trained based on prior communications between the first user and the second user. For example, if the first user requests location information of the second user each morning, such as a notification when the second user completes their workout, and the second user commonly responds with “Do you want me to pick up coffee?”, the system may recognize this pattern and begin to provide a prompt to the second user when the first user requests location information in the morning, the prompt asking if the second user wants to send that message.

In some examples, when automatically determining the at least one suggested next action, after verifying that the second user has authorized the system to access one or more applications, the system may identify an event scheduled for the second user. The event may have an event time and an event location. The system may compare the location information with the event location. Based on the comparison of the location information with the event location, the event tie, and the current time, the system may determine whether to send a second notification related to the event. The system may send the second notification to a third party and/or the first user.

In block 1050, the system may provide for output the at least one suggested next action. The at least one suggested next action may be provided to the first user or the second user. For example, the suggested next action may suggest to the first user to send a message to the second user, to take an action, such as unlocking a door or begin preparing a meal, etc. In other examples, the suggested next action may suggest to the second user to modify a travel route, to send a communication to the first user or a third party, to propose an update for an upcoming scheduled event, etc.

According to some examples, after the first user receives a notification based on the location information of the second user, the system may receive a response from the first user destined for the second user. According to some examples, the response may be a suggested next action for the first user. The response may be a preformulated message or a message generated by the first user destined for the second user. The response from the first user may relate to the location information of the second user. For example, the system may provide a navigation route to the second user to the destination location. Upon meeting the trigger condition, the system may provide information location to the first user. In response, the first user may alert the second user of dangers or potential delays along the navigation route. The suggested next action may be further based on the response from the first user. For example, the suggested next action may be for the second user to update a navigation route. The update to the navigation route may be based on the response provided by the first user.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method, comprising:
receiving, by one or more processors from a first or second user, a request for location information for the second user;
identifying, by the one or more processors, a trigger condition based on the request;
receiving, by the one or more processors based on an occurrence of the trigger condition, location information from the second user;
automatically determining, by the one or more processors based on at least the request for location information from the first user and the location information of the second user, at least one next action; and
providing for output, by the one or more processors, the at least one next action.

2. The method of claim 1, wherein identifying the trigger condition further comprises identifying, by the one or more processors, at least one parameter from the request for location information.

3. The method of claim 2, wherein identifying the at least one parameter is based on historical requests for location information or context of the request for location information.

4. The method of claim 1, further comprising receiving, by the one or more processors, a response from the first user destined for the second user, wherein the response relates to the location information of the second user.

5. The method of claim 4, wherein determining the at least one next action is further based on the response.

6. The method of claim 1, further comprising:
receiving, by the one or more processors from the second user, a request for directions to a destination location; and
providing, by the one or more processors, a navigation route to the destination location.

7. The method of claim 6, wherein the at least one next action includes updating the navigation route.

8. The method of claim 7, further comprising receiving, by the one or more processors, a response from the first user destined for the second user, wherein the response includes navigation information, and wherein updating the navigation route comprises automatically updating the navigation route based on the navigation information.

9. The method of claim 6, further comprising:
receiving, from the first user, a communication including information associated with the location information; and
interleaving, by the one or more processors, the information associated with the location information with the navigation route.

10. The method of claim 9, wherein the information associated with the location information includes a warning or a navigation suggestion.

11. The method of claim 1, wherein automatically determining the at least one next action comprises:
identifying, with the one or more processors, an event scheduled for the second user, the event having an event time and an event location;
comparing the location information with the event location;
determining, based on the comparing, an estimated arrival time of the second user at the event location; and
determining, based on the event time and the estimated arrival time, whether to send a second notification related to the event.

12. The method of claim 11, wherein the at least one next action comprises sending the second notification to a third party.

13. The method of claim 1, wherein the trigger condition limits a frequency of receiving the location information from a second user device of the second user.

14. The method of claim 1, further comprising transmitting, by the one or more processors to the first user, a first notification based on the received location information, wherein the first notification is a response to the request for location information.

15. A system, comprising:
one or more processors, the one or more processors configured to:
receive, from a first or second user, a request for location information for the second user;
identify a trigger condition based on the request;
receive, based on an occurrence of the trigger condition, location information from the second user;
automatically determine, based on at least the request for location information from the first user and the location information of the second user, at least one next action; and
provide for output the at least one next action.

16. The system of claim 15, wherein when identifying the trigger condition, the one or more processors are further configured to: identify at least on parameter from the request for location information.

17. The system of claim 16, wherein identifying the at least one parameter is based on historical requests for location information or context of the request for location information.

18. The system of claim 15, wherein the one or more processors are further configured to receive a response from the first user destined for the second user, wherein the response relates to the location information of the second user.

19. The system of claim 18, wherein determining the at least one next action is further based on the response.

20-28. (canceled)

29. A non-transitory computer-readable medium storing instructions, which when executed by one or more processors, cause the one or more processors to:
receive, from a first or second user, a request for location information for the second user;
identify a trigger condition based on the request;
receive, based on an occurrence of the trigger condition, location information from the second user;
automatically determine, based on at least the request for location information from the first user and the location information of the second user, at least one next action; and
provide for output the at least one next action.

30-42. (canceled)
